(19) United States
(12) Patent Application Publication
(10) Pub. No.: US 2009/0155591 A1
(43) Pub. Date: Jun. 18, 2009

(54) MICROPARTICLE HAVING NEEDLE-LIKE STRUCTURES ON SURFACE AND METHOD FOR PRODUCTION THEREOF

(75) Inventors: Ren-Hua Jin, Tokyo (JP); Pei-Xin Zhu, Sakura-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KAWAMURA INSTITUTE OF CHEMICAL RESEARCH, Sakura-shi, Chiba-ken (JP)

(21) Appl. No.: 11/996,415

(22) PCT Filed: Jul. 19, 2006
(86) PCT No.: PCT/JP2006/314266

§ 371 Date: Jan. 22, 2008

(30) Foreign Application Priority Data
Jul. 22, 2005 (JP) 2005-212740

(51) Int. Cl. B32B 1/00; C08F 122/00

(52) U.S. Cl. 428/405; 526/310

(57) ABSTRACT

The present invention provides an organic-inorganic composite microparticle containing a metal complex, which has multiple needle-like structures on the surface and includes the metal complex therein; and a method for producing the microparticle in a simple manner. By using a metal complex made from a polymer having a linear polyethyleneimine chain and a metal ion, a composite microparticle which has the metal complex in silica and has a micro-needle-like structures on the surface can be derived, thus a microparticle having needle-like structures on the surface is obtained, wherein there are nano-sized multiple needle-like structures on the surface of the microparticle. The needle-like structures on the surface and the spatial structure of the resulting microparticle can be controlled by varying the species of the metal ion and the types of the substrate medium for the metal complex.

### TECHNICAL FIELD

The present invention relates to a microparticle having needle-like structures on the surface, which has a needle-like micro-structure on surface and contains silica and a metal complex made from a polymer having a linear polyethyleneimine chain and a metal ion, and a method for producing the microparticle having needle-like structures on the surface.

### BACKGROUND ART

A composite material obtained by immobilizing a metal complex onto silica can be effectively applied in a chemical reaction catalyst, an electrochemistry sensor, and a solid polymer electrolyte. The studies to immobilize a metal complex onto mesoporous silica have generated considerable interest because the composite materials obtained by immobilizing a metal complex onto mesoporous silica show several promising advantages, such as having large specific surface area of silica, providing a broad distribution of complex active sites in nanocavities, having rapid diffusion of a substrate compound, and providing heat resistance and acid resistance of a catalyst carrier (see Non-patent references 1 to 6).

However, the metal complex in a conventional composite material composed of a metal complex and a silica is limited to a metal complex with a low molecular ligand. Therefore, it is difficult to adjust the content of the metal or silica in composite material to a desired value, and to distribute a metal complex uniformly in the composite material. As the morphology of the resulting composite material depends on the form (powder or orbicularity) of silica which is used as a raw material, a microparticle having micro-needle-like structures on the surface (morphology) is not formed.

As the production method includes a step of incorporating an amino or imino group into silica skeletons through a chemical bond and a step of coordinate-bonding the groups to metal ions to obtain a composite material, the method is complicated.

[Non-patent document 1] C. T. Kresge et al., Nature, 1992 Vol. 359, pp 710-712.

[Non-patent document 2] A. Monnier et al., Science, 1993 Vol. 261, pp 1299-1303.

[Non-patent document 3] S. A. Davis et al., Nature, 1997 Vol. 385, pp 420-423.

[Non-patent document 4] T. Kang et al., J. Mater. Chem., 2004 Vol. 14, pp 1043-1049.

[Non-patent document 5] B. Lee et al., Langmuir, 2003 Vol. 19, pp 4246-4252.

[Non-patent document 6] K. Zakir et al., Adv. Mater., 2002, Vol. 14, pp 1053-1056.

### DISCLOSURE OF THE INVENTION

An object to be achieved by the present invention is to provide a microparticle having needle-like structures on the surface, which contains a metal complex of a polymer having a linear polyethyleneimine chain and has needle-like micro-structures on the surface with a large surface area, and a simple production method thereof.

The present inventors have intensively studied so as to achieve the above object, and thus it was found that it is easy to obtain a metal complex (X) by incorporating a metal ion (b) into a polymer (a) having a linear polyethyleneimine chain, and an association was formed by mutually associating the metal complex (X) in the presence of water, and a microparticle which has micro-needle-like structures on the surface and includes the metal complex (X) inside the silica was obtained by carrying out a sol-gel reaction using alkoxysilane at the association of the metal complex (X) as a reaction field. As a result the invention was completed.

The present invention provides a microparticle having needle-like structures on the surface which includes a polymer (a) having a linear polyethyleneimine chain, a metal ion (b) which can form a complex with the polymer, and silica (Y), and the microparticle has micro-needle-like structures on the surface.

Also, the present invention provides a microparticle having needle-like structures on the surface which includes a metal complex (X) made from the polymer (a) having a linear polyethyleneimine chain and the metal ion (b), and silica (Y), and the microparticle has micro-needle-like structures on the surface.

Furthermore, the present invention provides a method for producing a microparticle having needle-like structures on the surface, including:

(1) a step of dissolving a polymer (a) having a linear polyethyleneimine chain and a metal ion (b) into an aqueous medium to obtain an association of a metal complex (X) made from the polymer (a) having the linear polyethyleneimine chain and the metal ion (b); and

(2) a step of carrying out a sol-gel reaction using alkoxysilane at the association of the metal complex (X) as a reaction field in the presence of water.

The surface area of the microparticle enlarges markedly, compared with a conventional simple microparticle, because there are numerous nano-sized needle-like structures on the surface of the microparticle having needle-like structures on the surface of the present invention. The microparticle of the present invention has the characteristics of the polyethyleneimine chain, because the microparticle contains a polyethyleneimine chain inside, which has an excellent ability for concentration and reduction of the metal ions.

The microparticle having needle-like structures on the surface of the present invention was produced by the method forming an association of a metal complex made from a polymer having a linear polyethyleneimine chain and a metal ion and deriving a silica particle having needle-like structures on the surface by a sol-gel reaction at the association as a reaction field, and as a result, introducing the polymer metal complex into the silica inside. As the method is different from the conventional method in which a metal complex was immobilized on mesoporous silica, a microparticle having a uniform distribution of a metal complex can be obtained using the method of the present invention. The obtained needle-like structures on the surface and a spatial structure of the microparticle having needle-like structures on the surface can be controlled easily by changing the species of metal, or constitutions or configurations of the polymer having a linear polyethyleneimine chain. The morphology can be varied, and can be designed according to purposes.

Furthermore, the ethyleneimine unit in the linear polyethyleneimine chain can form a complex with various metal ions, such as an alkali metal, an alkaline-earth metal, a transition metal, so the microparticle having needle-like structures on the surface can contain those various metal ions. The silica microparticle including a polymer metal complex can be obtained by a single method independent of the metal ions, and it is also easy to prepare a microparticle having several species of metal ions.

The microparticle having needle-like structures on the surface of the present invention is a promising candidate for use in a solid electrolyte, a solid catalyst, a nanoadditive, and a nanothin-film material. In addition, the microparticle having needle-like structures on the surface which includes a metal complex of the metal ions can be changed into a metal nanoparticle by heating a treatment or a treatment using a reducing agent, so it is also a promising candidate for use in materials containing metal nanoparticles.

The method for producing a microparticle having needle-like structures on the surface includes a step of dissolving a polymer (a) having a linear polyethyleneimine chain and a metal ion into an aqueous medium to obtain an association of a metal complex (X), and a step of carrying out a sol-gel reaction using alkoxysilane at the association of the metal complex (X) as a reaction field in the presence of water. It is a simple method without the need of a special device, so it can be used as a production method in industry.

### BRIEF DESCRIPTION OF DRAWINGS

FIG. 1 is a scanning electron micrograph of microparticles having needle-like structures on the surface in Example 1 of the present invention.

FIG. 2 is a scanning electron micrograph of the surface of microparticles having needle-like structures on the surface in Example 1 of the present invention.

FIG. 3 is a scanning electron micrograph of microparticles having needle-like structures on the surface in Example 2 of the present invention.

FIG. 4 is a scanning electron micrograph of the surface of microparticles having needle-like structures on the surface in Example 2 of the present invention.

FIG. 5 is a scanning electron micrograph of microparticles having needle-like structures on the surface in Example 3 of the present invention.

FIG. 6 is a scanning electron micrograph of the surface of microparticles having needle-like structures on the surface in Example 3 of the present invention.

FIG. 7 is a scanning electron micrograph of microparticles having needle-like structures on the surface in Example 4 of the present invention.

FIG. 8 is a scanning electron micrograph of the surface of microparticles having needle-like structures on the surface in Example 4 of the present invention.

FIG. 9 is a scanning electron micrograph of microparticles having needle-like structures on the surface in Example 5 of the present invention.

FIG. 10 is a scanning electron micrograph of the surface of microparticles having needle-like structures on the surface in Example 5 of the present invention.

FIG. 11 is a scanning electron micrograph of composite material in Comparative Example.

### BEST MODE FOR CARRYING OUT THE INVENTION

The microparticle having needle-like structures on the surface of the present invention includes a metal complex (X) made from a polymer (a) having a linear polyethyleneimine chain and at least one species of a metal ion (b), and silica (Y), wherein the microparticle has micro-needle-like structures on the surface.

[Polymer (a) Having a Linear Polyethyleneimine Chain]

The linear polyethyleneimine chain in the present invention means a linear polymer chain having an ethyleneimine unit of a secondary amine as a main structural unit. In the chain, a structural unit other than the ethyleneimine unit may exist. However, it is preferable that a part of the chain with a desired length is continuous ethyleneimine units. The length of the linear polyethyleneimine chain is preferably within a range such that an association of a metal complex (X) made from a polymer (a) and a metal ion (b) can be formed, after a metal complex (X) is formed by coordinate bonding a polymer containing the linear chain to a metal ion (b). In order to form an association of a metal complex (X), the number of ethyleneimine repeating units of the chain moiety is preferably 10 or more, and particularly preferably within a range from 20 to 10,000. A linear polyethyleneimine has solubility in heated water, but it is a crystalline association at room temperature by crystallization. These crystals dissolve only in limited organic solvents. It is completely different from that of the branched polymer obtained by a primary amine, a secondary amine or a tertiary amine, which is not a crystalline polymer and can completely dissolve in water and a normal organic solvent. A linear polyethyleneimine is crystallized to form a conformation of a double helix or an all-trans zigzag through a strong hydrogen bond between repeating units —CH₂—CH₂—NH— in a molecule chain. However, a branched polyethyleneimine can not be crystallized because there is no spatial structure for forming a hydrogen bond. A polymer (a) having a linear polyethyleneimine chain of the present invention has the above-mentioned special property of a linear polyethyleneimine chain, and the microparticle of the present invention was obtained by using this property.

The polymer (a) containing a linear polyethyleneimine chain used in the present invention (hereinafter abbreviated to polymer (a)) may have the linear polyethyleneimine chain in the structure, and the configuration may be a linear, star-shaped, or comb-shaped one. A metal complex (X) can be formed by coordinate bonding an ethyleneimine unit to a metal ion (b) in an aqueous medium (here, the aqueous medium means water or a mixed solvent of water and an aqueous organic solvent), because the polymer (a) has a linear polyethyleneimine chain.

The polymer (a) may be composed only of a linear polyethyleneimine chain, or may be composed of a block copolymer having a block of a linear polyethyleneimine chain (hereinafter abbreviated to a polyethyleneimine block) and another polymer block. As the other polymer block, for example, a water-soluble polymer block such as polyethylene glycol, polypropionylethyleneimine, or polyacrylamide; or a hydrophobic polymer block such as polystyrene, polyoxazolines including polyphenyloxazoline, polyoctyloxazoline, and polydodecyloxazoline, or polyacrylates including polymethyl methacrylate and polybutyl methacrylate can be used. The shape of the association of a metal complex (X) can be adjusted by forming a block copolymer with the other polymer block, and as a result, the shape or characteristics of the resulting microparticle having needle-like structures on the surface can be adjusted.

When the polymer (a) is a block copolymer, the content of a linear polyethyleneimine chain in the polymer (a) is not specifically limited as long as an association of a metal complex (X) can be formed. In order to suitably form an association of a metal complex (X), the content of the linear polyethyleneimine chain in the polymer (a) is preferably 40 mol % or more, more preferably 50 mol % or more.

The method for producing the polymer (a) is not specifically limited as long as the polymer (a) can be easily obtained by hydrolyzing a polymer including a linear polyoxazoline chain as a precursor (hereinafter abbreviated to a precursor polymer) under acid conditions or alkali conditions. Therefore, a linear, star-shaped, or comb-shaped configuration of the polymer (a) can be easily designed by controlling the configuration of the precursor polymer. The polymerization degree and the end structure can be easily adjusted by controlling the polymerization degree or the end functional group of the precursor polymer. Furthermore, when the polymer (a) is a block copolymer, the linear polyethyleneimine chain can be obtained by selectively hydrolyzing a linear polyoxazoline chain in the precursor polymer as a block copolymer including a linear polyoxazoline chain and the other polymer block.

The precursor polymer can be synthesized by a cationic polymerization method, or a synthesis method such as a macromonomer method using a monomer of oxazolines, and precursor polymers having various configurations such as a linear, star-shaped, or comb-shaped configuration can be synthesized by appropriately selecting a synthesis method or an initiator.

As the monomer which forms a linear chain made of polyoxazolines, for example, an oxazoline monomer such as methyloxazoline, ethyloxazoline, methylvinyloxazoline, or phenyloxazoline can be used.

As the polymerization initiator, for example, a compound having a functional group such as an alkyl chloride group, an alkyl bromide group, an alkyl iodide group, a toluenesulfonyloxy group, or a trifluoromethylsulfonyloxy group in the molecule can be used. These polymerization initiators can be obtained by converting hydroxyl groups of numerous alcohol compounds into other functional groups. Those which are brominated, iodided, toluenesulfonated and trifluoromethylsulfonated by conversion into the functional group are preferable because of high polymerization initiation efficiency, and alkyl bromide and alkyl toluenesulfonate are particularly preferable.

Those obtained by converting a terminal hydroxyl group of poly(ethylene glycol) into bromine, iodine, or a toluenesulfonyl group can also be used as the polymerization initiator. In this case, the polymerization degree of poly(ethylene glycol) is preferably within a range from 5 to 100, and particularly preferably from 10 to 50.

Pigments which include a functional group having an ability of cationic ring-opening living polymerization initiation and include any of porphyrin chains, phthalocyanine chains and pyrene chains, which have a light-inducing light emitting function, energy transfer function, or electron transfer function, can provide a special function to the resulting polymer, and as a result, can provide a special function to the resulting microparticles having needle-like structures on the surface.

The linear precursor polymer is obtained by polymerizing the oxazoline monomer using a polymerization initiator having a monovalent or divalent functional group. Examples of the polymerization initiator include a polymerization initiator having a monovalent functional group such as methylbenzene chloride, methylbenzene bromide, methylbenzene iodide, methylbenzene toluenesulfonate, methylbenzene trifluoromethylsulfonate, methane bromide, methane iodide, methane toluenesulfonate or toluenesulfonic anhydride, trifluoromethylsulfonic anhydride, 5-(4-bromomethylphenyl)-10,15,20-tri(phenyl)porphyrin, or bromomethylpyrene; and a polymerization initiator having a divalent functional group such as dibromomethylbenzene, methylbenzene diiodide, dibromomethylbiphenylene, or dibromomethylazobenzene. Also, a linear polyoxazoline, which is industrially used, such as poly(methyloxazoline), poly(ethyloxazoline), or poly(methylvinyloxazoline) can be used as a precursor polymer as it is.

The star-shaped precursor polymer can be obtained by polymerizing the oxazoline monomer using a polymerization initiator having a tri- or polyvalent functional group. Examples of the tri- or polyvalent polymerization initiator include a polymerization initiator having a trivalent functional group such as tribromomethylbenzene; a polymerization initiator having a tetravalent functional group such as tetrabromomethylbenzene, tetra(4-chloromethylphenyl)porphyrin, or tetrabromoethoxyphthalocyanine; and a polymerization initiator having a hexa- or polyvalent functional group such as hexabromomethylbenzene or tetra(3,5-ditosylethyloxyphenyl)porphyrin.

The comb-shaped precursor polymer can be obtained by polymerizing an oxazoline monomer from a polymerization initiation group using a linear polymer having a polyvalent polymerization initiation group. For example, a hydroxyl group of a polymer having a hydroxyl group in the side chain such as an epoxy resin or a polyvinyl alcohol is halogenated by bromine or iodine, or converted into a toluenesulfonyl group, and then the converted moiety can be used as the polymerization initiation group.

In the method of obtaining a comb-shaped precursor polymer, a polyamine type polymerization terminator can also be used. For example, a comb-shaped polyoxazoline can be obtained by polymerizing oxazoline using a monovalent polymerization initiator, thereby bonding the end of polyoxazolines to an amino group of polyamine such as polyethyleneimine, polyvinylamine, or polypropylamine.

The linear chains made of polyoxazolines of the resulting precursor polymer may be hydrolyzed under acid conditions or alkali conditions.

In the hydrolysis under acid conditions, hydrochloride of polyethyleneimine can be obtained by stirring polyoxazoline under heating in an aqueous hydrochloric acid solution. A crystal powder of a basic polyethyleneimine can be obtained by treating the resulting hydrochloride with excess ammonia water. The aqueous hydrochloric acid solution to be used may be a concentrated hydrochloric acid or an aqueous solution having a concentration of about 1 mol/L. In order to efficiently conduct hydrolysis, an aqueous hydrochloric acid solution having a concentration of 5 mol/L is preferably used. The reaction temperature is preferably about 70-90° C.

Hydrolysis under alkali conditions can convert polyoxazoline into polyethyleneimine using an aqueous sodium hydroxide solution. After reacting under alkali conditions, excess sodium hydroxide is removed by washing the reaction solution with a dialysis membrane, and then a powder of polyethyleneimine can be obtained. The concentration of sodium hydroxide to be used may be within a range from 1 to 10 mol/L, and is preferably from 3 to 5 mol/L so as to efficiently conduct the reaction. The reaction temperature is preferably about 70-90° C.

The amount of an acid or an alkali in the hydrolysis under acid conditions or alkali conditions may be within a range from 1 to 10 equivalents based on an oxazoline unit in the polymer (a), and is preferably about 2 to 4 equivalents so as to improve reaction efficiency and to simplify an aftertreatment.

The linear chains made of polyoxazolines in the precursor polymer are converted into linear polyethyleneimine chains by the hydrolysis, and thus a polymer including the polyethyleneimine chains can be obtained.

In order to form a block copolymer composed of a linear polyethyleneimine block and the other polymer block, a block copolymer composed of a linear polymer chain block made of polyoxazolines and the other polymer block can be used as a precursor polymer, and then the linear chain block made of polyoxazolines in the precursor polymer can be selectively hydrolyzed.

When the other polymer block is a water-soluble polymer block such as poly(N-propionylethyleneimine), a block copolymer can be formed by making use of the fact that poly(N-propionylethyleneimine) has higher solubility in an organic solvent than that of poly(N-formylethyleneimine) or poly(N-acetylethyleneimine). That is, a precursor polymer made of a poly(N-formylethyleneimine) block or a poly(N-acetylethyleneimine) block, and a poly(N-propionylethyleneimine) block is obtained by subjecting 2-oxazoline or 2-methyl-2-oxazoline to cationic ring-opening living polymerization in the presence of the polymerization initiation compound and polymerizing the resulting living polymer with 2-ethyl-2-oxazoline. An emulsion is formed by dissolving the precursor polymer in water and mixing the resulting aqueous solution with an organic solvent which is incompatible with water that dissolves the poly(N-propionylethyleneimine) block, followed with stirring. By adding an acid or alkali to an aqueous phase of the emulsion, the poly(N-formylethyleneimine) block or the poly(N-acetylethyleneimine) block is preferentially hydrolyzed, and thus a block copolymer made of a linear polyethyleneimine chain block and a poly(N-propionylethyleneimine) block can be formed.

When the polymerization initiation compound used herein has a valence of 1 or 2, a linear block copolymer is obtained. When the valence is more than the above range, a star-shaped block copolymer is obtained. When a multi-stage polymer is used as the precursor polymer, a polymer having a multi-stage block structure can be obtained.

[Metal Ions (b)]

Metal ions (b) in the present invention are those which are used to form a metal complex (X) through coordinate bonding with ethyleneimine units in a polyethyleneimine chain because of a strong coordinative ability of the polyethyleneimine chain in the polymer (a). The metal complex (X) is obtained through coordinate bonding of the metal ions (b) and the ethyleneimine units. Unlike the process of ionic bond, the complex can be formed through coordinate bonding of ethyleneimine units and metal ions (b) even if the metal ion is a cation or a metal oxide anion. Therefore, metal species of the metal ions (b) are not specifically limited as long as they can be coordinate-bonded to the ethyleneimine units in the polymer (a), and examples thereof include alkali metals, alkali earth metals, transition metals, metals of Group 12 of the Periodic Table, metalloids of Group 13 to 16 of the Periodic Table, lanthanum-based metals, and metal compounds of polyoxometalates, and particularly, alkali metals, alkali earth metals, rare earth metals, transition metals, metals of Group 12 of the Periodic Table, and metalloids of Group 13 to 16 of the Periodic Table can be preferably used.

Examples of the alkali metal ions include ions of Li, Na, K, and Cs. As a counter anion of the alkali metal ions, Cl, Br, I, NO₃, SO₄, PO₄, ClO₄, PF₆, BF₄, and F₃CSO₃ can be preferably used.

Examples of the alkali earth metal ions include ions of Mg, Ba, and Ca.

A transition metal-based ion can be preferably used for formation of a complex even if it is a transition metal cation (Mⁿ⁺), or the transition metal is an acid radical anion (MOₓⁿ⁻) bonded to oxygen or an anion (MLₓⁿ⁻) bonded to halogens. As used herein, transition metal means Sc and Y of Group 3 of the Periodic Table, and Periods 4-6 transition metal elements of Groups 4 to 12.

Examples of the transition metal cation include cations (Mⁿ⁺) of the following transition metals, for example, mono-, di-, tri- and tetravalent cations of Ti, V, Cr, Mn, Fe, Co, Ni, Cu, Zn, Y, Zr, Mo, Ru, Rh, Pd, Ag, Cd, W, Os, Ir, Pt, Au, and Hg. A counter anion of these metal cations may be Cl, NO₃, SO₄, or a polyoxometalate anion, or an organic anion of carboxylic acids. When the cations are those of Ag, Au, and Pt which are likely to be reduced by polyethyleneimine chains, a complex is preferably prepared by suppressing the reducing reaction, for example, by adjusting the pH to acid conditions.

Examples of the transition metal anion include the following transition metal anions (MOₓⁿ⁻), for example, anions of MnO₄, MoO₄, ReO₄, WO₃, RuO₄, CoO₄, CrO₄, VO₃, NiO₄, and UO₂.

The metal ions (b) of the present invention may be a form of a metal compound of polyoxometalates in which the above-mentioned transition metal anion is immobilized on silica via metal cations coordinate-bonded to the ethyleneimine units in the polymer (a). Specific examples of the polyoxometalates include molybdates, tungstates and vanadates combined with the transition metal cations.

Furthermore, an anion (MLₓⁿ⁻) including the following metals, for example, an anion in which the metal is coordinate-bonded to a halogen, such as AuCl₄, PtCl₆, RhCl₄, ReF₆, NiF₆, CuF₆, RuCl₆, and In₂Cl₆ can be preferably used for formation of a complex.

As metal elements of Group 12 of the Periodic Table, Zn, Cd, Hg can be used. Examples of the metalloid-based ion include ions of Al, Ga, In, Tl, Ge, Sn, Pb, Sb, and Bi. Among these ions, ions of Al, Ga, In, Sn, Pb, and TI are preferable.

Examples of the lanthanum-based metal ions include trivalent cations of La, Eu, Gd, Yb, and Eu.

[Metal Complex (X)]

The metal complex (X) of the present invention is obtained by coordinate-bonding metal ions (b) with an ethyleneimine unit in a polymer (a). The metal complex (X) produces an association by associating mutually in the presence of water, and derives needle-like structures on the surface.

In the formation of the metal complex (X) made from the polymer (a) and metal ions (b), it is preferable that a mole ratio of an ethyleneimine unit in the polymer (a) to the metal ions (b) be within a range from 5/1 to 100/1, but it is more preferable that the ratio be within a range from 10/1 to 30/1 in order to derive needle-like structures on the surface effectively.

One species, or two species or more of the metal ions (b) may be used at the same time in formation of the metal complex (X).

The medium used in coordinate-bonding the polymer (a) to the metal ions (b) may be water only or an aqueous medium made of water and an organic solvent which can mutually dissolve with water.

Examples of the organic solvent include methanol, ethanol, acetone, dioxirane, THF, DMF, and DMSO.

When the organic solvent is used, it is preferable that the volume ratio of water to organic solvent be within a range from 1/1 to 3/1, in order that the association of the metal complex (X) can be adjusted effectively.

[Silica (Y)]

As the silica (Y) in the microparticle having needle-like structures on the surface of the present invention, silica obtained by hydrolysis and condensation of alkoxysilanes as a silica source can be used.

[Microparticle Having Needle-Like Structures on the Surface]

The microparticle having needle-like structures on the surface of the present invention is obtained by composition of the above-mentioned metal complex (X) and silica (Y), wherein there are dense micro-needle-like structures on the surface of the microparticle.

The microparticle having needle-like structures on the surface of the present invention has a largest diameter from 0.1 to 100 μm, and preferably from 1 to 20 μm and the particles are approximately monodisperse. The shapes of the particles are disk or spherical. An individual particle is characterized by having numerous micro-needle-like structures on the surface independent of the particle shape. The average thickness of a needle-like structure is within a range from several nm to several ten nm, and preferably from 10 to 80 nm.

The shape of the microparticle having needle-like structures on the surface of the present invention and the thickness of the needle-like structure depend on the geometric shape of the structure of the polymer (a), molecular weight, the non-ethyleneimine moiety which can be incorporated in the polymer (a), the structure of the complex made from the polymer (a) and the metal ions (b), the species of the metal ions (b), the concentration of the metal ions (b), and are particularly influenced by the molecular structure, the polymerization degree, and the composition of the polymer (a), and the species of metal and the concentration of the metal in coordination of the polymer and the metal ions (b).

The content of silica (Y) in the microparticle having needle-like structures on the surface of the present invention is not specifically limited as long as various structures can be constructed, but is preferably within a range from 30 to 90%, and more preferably 20 to 80%, by mass because various structures can be stably formed. The content of metal ions (b) can be appropriately adjusted according to various applications, but is preferably within a range from 0.05 to 5% by mass because it can be efficiently produced by the method as described below.

As there is a metal complex (X) in the microparticle inside, the microparticle having needle-like structures on the surface of the present invention has the characteristics which the metal complex (X) has. For example, the concentration or reduction ability of the metal ions comes from the linear polyethyleneimine chain in the polymer (a), or the functions of a functional material are provided by incorporating the functional material in the polymer (a).

In detail, a fluorescent material can be incorporated in the polymer (a). For example, a residual group of porphyrin can be incorporated in the microparticle having needle-like structures on the surface by using a star-shaped polyethyleneimine centered by porphyrin. In addition, for example, a residual group of pyrene can be incorporated in the microparticle having needle-like structures on the surface by using the polymer (a) obtained by reacting the side chain of the linear polyethyleneimine chain with a small amount of pyrenes, such as pyrene aldehyde (preferably 10 mol % or less to imine). More particularly, a fluorescent material can be incorporated in the microparticle having needle-like structures on the surface obtained by using the association as a template, wherein the association is obtained by mixing the polymer (a) and a small amount of a fluorescent material (preferably 0.1 mol % or less to imine), such as porphyrins having an acid group, such as carboxylic acid group or a sulfone acid group, phthalocyanines, or pyrenes, and then mixing them with the metal ions (b).

The microparticle having needle-like structures on the surface described as above, has a large surface area and it can be expected that various nano-size effects that cannot be obtained by a conventional microparticle are developed, because there are numerous nano-sized needle-like structures on the surface of the microparticle. Inside the microparticle, there is not only a polyethyleneimine chain which has superior ability in concentration and reduction of metal ions, but also a polymer whose structure can be controlled variously. Therefore, the microparticle also has characteristics resulting from the polyethyleneimine chain.

The microparticle having needle-like structures on the surface of the present invention is formed by deriving a silica particle having needle-like structures from a polymer-and-metal complex made from a polymer composed of a linear polyethyleneimine chain and metal ions, and as a result, incorporating the polymer metal complex inside the silica. Thus, the resulting needle-like structures and spatial structures of the composite material can be controlled by changing the species of the metal ions and the medium on which the metal complex is incorporated. Particularly, the linear polyethyleneimine chain used to form metal complex can form a complex with various metal ions, such as an alkali metal, an alkaline-earth metal, and a transition metal. Therefore, the microparticle having needle-like structures on the surface can contain the above-mentioned metal ions.

The microparticle having needle-like structures on the surface of the present invention can be expected to be used in various applications, such as a solid electrolyte, a solid catalyst, a nano-additive, and nano-film materials. In addition, the microparticle having needle-like structures on the surface which includes a metal complex of the metal ions, can be changed into a metal nanoparticle by a heating treatment or a treatment of a reducing agent, so there is application in material containing metal nanoparticles.

[Method for Producing a Microparticle Having Needle-Like Structures on the Surface]

The method for producing a microparticle having needle-like structures on the surface of the present invention includes

(1) a step of dissolving a polymer (a) having a linear polyethyleneimine chain and a metal ion (b) into an aqueous medium to obtain an association of a metal complex (X) made from the polymer (a) having the linear polyethyleneimine chain and the metal ion (b); and

(2) a step of carrying out a sol-gel reaction using alkoxysilane at the association of the metal complex (X) as a reaction field in the presence of water.

The polymer (a) and the metal ion (b) form a metal complex (X) by complexation of plural ethyleneimine units in the polymer (a). The complexation can occur not only between a single metal ion (b) and ethyleneimine units in plural polymer molecules, but also between a single metal ion (b) and plural ethyleneimine units in a single polymer molecule.

The metal complex (X) assembles to form an association in the presence of water. It utilizes the property that the linear polyethyleneimine dissolves in heated water to obtain a uniform solution, but it crystallizes at room temperature. When the heated water in which the polymer (a) and the metal ion (b) dissolve uniformly is cooled, the resulting complex (X) assembles to form an association and desired morphology which depend upon a polymer (a) and the species and concentration of metal ion (b) can be obtained, because the polymer (a) having a linear polyethyleneimine chain forms an aggregation easily at room temperature in the presence of water by intermolecular force. And the association behaves as a template in the next step (in sol-gel reaction).

In addition, there are numerous free brush-like polyethyleneimine chains in the association of the metal complex (X) inevitably. The brush is a base to draw a silica source to, and it also works as a catalyst of polymerizing a silica source at the same time.

The surface of an association of a metal complex is coated by silica through a hydrolysis and condensation reaction of alkoxysilane on the surface of an association of a metal complex. As a result, the composite microparticle including a metal complex inside and composed of an association of a metal complex and silica, is obtained. Micro-needle-like structures are derived on the surface of the composite microparticle by copying the shape of the association of the metal complex to silica. Therefore, the shape of the resulting microparticle having needle-like structures on the surface can be controlled by controlling the shape of an association of a metal complex. Furthermore, the content of a metal ion or silica in the microparticle can be adjusted easily, and the uniform distribution of a metal ion or silica in the microparticle can be achieved.

The production method of the present invention is explained in detail as follows.

At first, as the first process, a step of dissolving a polymer (a) having a linear polyethyleneimine chain and a metal ion (b) in an aqueous medium to obtain an association of a metal complex (X) made from the polymer (a) having the linear polyethyleneimine chain and the metal ion (b) is carried out. Here, the polymer (a) having a linear polyethyleneimine chain is the same as the above-mentioned polymer (a).

A polyethyleneimine chain can form a complex with a metal ion because it have repeating ethyleneimine units which are similar to an ethylenediamine can form a complex strongly with a metal ion. The metal ions which can form a metal complex with a polyethyleneimine chain are all metals in the element periodic table. Therefore, a metal complex (X) can be formed when the metal ion (b) is mixed with a polymer (a) in an aqueous medium.

As the polymer (a) is easy to crystallize in the presence of water, it is easy to form a crystal when there is a polymer (a) only. When there are metal ions (b), crystal growing of an ethyleneimine unit becomes disorderly, and a metal complex (A) is formed between ethyleneimine units and a metal ion (b). In the metal complex (X), the metal ion behaves as a cross-linker of the polymers, and then an association of a metal complex (X) is derived unlike a pure crystal of a polymer. As a result, a desired morphology is obtained.

The polyethyleneimine which has hitherto been used widely is a branched polymer obtained by ring-opening polymerization of a cyclic ethyleneimine. In the branched polymer there are structures including a primary amine, a secondary amine and a tertiary amines. Therefore, the morphology cannot be obtained even if the branched polyethyleneimine is used to form a complex with a metal ion, because the branched polyethyleneimine is water-soluble but has no crystallinity.

In contrast, in the present invention, an association of a metal complex (X) is formed as above because a linear polyethyleneimine chain is used. An association of a metal complex (X) can be obtained when the polymer has a linear polyethyleneimine chain, even if the polymer has a linear, star or comb structure.

A metal complex (X) can be prepared by stirring a polymer (a) and a metal ion (b) in water. Preferably, a polymer (a) is dispersed in an aqueous medium, and then the transparent aqueous solution is obtained by heating the dispersing medium in which the polymer (a) is dissolved. Subsequently, a metal ion (b) is added to the aqueous solution of the polymer (a) while the heating process is carried out, and then the aqueous solution is cooled to room temperature. An association of a metal complex (X) can also be obtained during the above process.

As the temperature of heating the above polymer dispersing medium, 100° C. or less is preferable, and the range from 60 to 95° C. is more preferable. As the method to cool the mixture in a heating state, it is preferable that the container having the mixture be cooled naturally under air atmosphere, and it is more preferable that it is cooled by cold water or iced water. It is also possible to cool the mixture to 25° C. by using a step-by-step control method at a desired temperature step for a desired time. During the cooling process, the morphology of an association of a metal complex (X) can be changed.

The content of the polymer (a) in the polymer dispersing medium is not specifically limited as long as an association of the metal complex (X) can be formed, but is preferably within a range of 0.01 to 20%, more preferably 0.1 to 10% by mass because a stable association of a metal complex (X) can be obtained. As described above, in the present invention in which the polymer (a) is used, the association can be formed even if an extremely small concentration of polymer is used.

When an association of a metal complex (X) is formed, it is preferable that the ratio of ethyleneimine units of the polymer (a) to the metal ion (b), expressed by ethyleneimine units/metal ion (b), be within a range from 5/1 to 100/1, and more preferable within a range from 10/1 to 50/1 in order to derive needle-like structures on surface, effectively. Metal ions can be preferably used not only when they are one species, but also when they are two species or more and are used at the same time.

An aqueous medium used is water or a mixed solvent having water and an organic solvent. Examples of the organic solvent which can mutually dissolve with water include methanol, ethanol, acetone, dioxirane, THF, DMF, and DMSO. When the organic solvent is used, it is preferable that the volume ratio of water to organic solvent be within a range from 1/1 to 3/1.

As a production method of the present invention, following the above step, (2) a sol-gel reaction is carried out using alkoxysilane at the association of the metal complex (X) as a reaction field in the presence of water.

As described above, the metal complex (X) assembles to form an association in the presence of water. After adding a solution obtained by dissolving a silica source (alkoxysilane) in a solvent which is usually used in the sol-gel reaction, a hydrolysis and condensation reaction of alkoxysilane can occur at room temperature.

Examples of the alkoxysilane used as the silica source include tri- or polyvalent alkoxysilanes such as tetraalkoxysilanes and alkyltrialkoxysilanes.

Examples of the tetraalkoxysilanes include tetramethoxysilane, tetraethoxysilane, tetrapropoxysilane, and tetrabutoxysilane.

Examples of the alkyltrialkoxysilanes include methyltrimethoxysilane, methyltriethoxysilane, ethyltrimethoxysilane, ethyltriethoxysilane, n-propyltrimethoxysilane, n-propyltriethoxysilane, iso-propyltrimethoxysilane, iso-propyltriethoxysilane, 3-chloropropyltrimethoxysilane, 3-chloropropyltriethoxysilane, vinyltrimethoxysilane, vinyltriethoxysilane, 3-glycidoxypropyltrimethoxysilane, 3-glycidoxypropyltriethoxysilane, 3-aminopropyltrimethoxysilane, 3-aminopropyltriethoxysilane, 3-mercaptopropyltrimethoxysilane, 3-mercaptopropyltriethoxysilane, 3,3,3-trifluoropropyltrimethoxysilane, 3,3,3-trifluoropropyltriethoxysilane, 3-methacryloxypropyltrimethoxysilane, 3-methacryloxypropyltriethoxysilane, phenyltrimethoxysilane, phenyltriethoxysilane, p-chloromethylphenyltrimethoxysilane, p-chloromethylphenyltriethoxysilane, dimethyldimethoxysilane, dimethyldiethoxysilane, diethyldimethoxysilane, and diethyldiethoxysilane.

The hydrolysis and condensation reaction (sol-gel reaction), which provides the microparticles having needle-like structures on the surface, is carried out in the presence of water and an association of the metal complex (X), but the reaction does not occur in homogeneous water phase and occurs on the surface of an association of the metal complex (X). Therefore, the reaction is conducted under any reaction conditions unless the association of the metal complex (X) is dissolved.

In order to make the association of the metal complex (X) insoluble, when an aqueous medium containing a hydrophilic organic solvent is used, the content of water in an aqueous medium is preferably adjusted to 20% or more, and more preferably 40% or more, in the hydrolysis and condensation reaction.

In the hydrolysis and condensation reaction, when the amount of the alkoxysilane as the silica source is in excess relative to the amount of the ethyleneimine units as monomer units of the polyethyleneimine, microparticles having needle-like structures on the surface can be suitably formed. The excess amount is preferably 2 to 1000 times relative to the amount of the ethyleneimine units.

The time of the hydrolysis and condensation reaction ranges from one minute to several days. In the case of methoxysilanes which have high reaction activity of the alkoxysilane, the reaction time is preferably from one minute to 24 hours and more preferably from 30 minutes to 5 hours so as to increase the reaction efficiency. In the case of ethoxysilanes and butoxysilanes which have low reaction activity, the sol-gel reaction time is preferably 24 hours or more, and more preferably about one week.

The microparticle having needle-like structures on the surface are a microparticle having various shapes and the surface of the microparticle has micro-needle-like structures. However, the shapes and structures are derived from the association of the metal complex (X). Therefore, the shape and structure of the microparticle having needle-like structures on the surface can be controlled by controlling the associating state of the association of the metal complex (X) in water or an aqueous medium before the hydrolysis and condensation reaction. The preparation of an association of a metal complex (X) in water or an aqueous medium has been described as above.

The content of the silica (Y) in a microparticle having needle-like structures on the surface varies within a desired range according to the reaction conditions, and increases with increase of the amount of the polymer (a) used in the case of the sol-gel reaction, which is the concentration of the polymer (a) forming a metal complex (X). It is also possible to increase the content of the silica by increasing the hydrolysis and condensation reaction time. A desired microparticle can be obtained by controlling the above reaction conditions.

The production method of the present invention can provide a microparticle having needle-like structures on the surface quickly by using an extremely easy method as described as above. Even more particularly, the provided microparticle is monodisperse.

### EXAMPLES

The present invention will now be described in detail by way of examples and reference examples, but the present invention is not limited thereto. Percentages are by mass unless otherwise specified.

[Shape Analysis by Scanning Electron Microscope]

An isolated and dried sample was placed on a glass slide and the sample was observed by a surface observation apparatus VE-7800 manufactured by KEYENCE CORPORATION.

[Measurement of Metal Content in Silica by ICP]

An isolated and dried sample was weighed and decomposed in microwave decomposition equipment. Ultrapure water was added to the resulting decomposition solution, and then the metal content of the resulting solution was measured using an Optima 3300DV manufactured by Perkin Elmer Company. After the measurement, the metal content was calculated.

### Synthesis Example 1

### Synthesis of Linear Polyethyleneimine (L-PEI)

3 g of a commercially available polyethyloxazoline (number average molecular weight: 50,000, average polymerization degree: 5,000, manufactured by Aldrich Co.) was dissolved in 15 mL of an aqueous 5 M hydrochloric acid solution. The solution was heated to 90° C. in an oil bath and then stirred at the same temperature for 10 hours. To the reaction solution, 50 mL of acetone was added, thereby the polymer was completely precipitated. After filtration the polymer and further washing it with methanol three times, a white powder of polyethyleneimine was obtained. The resulting powder was identified by ¹H-NMR (heavy water) and it was confirmed that peaks at 1.2 ppm (CH₃) and 2.3 ppm (CH₂) attributed to an ethyl side chain group of polyethyloxazoline completely disappeared. This fact showed that polyethyloxazoline was completely hydrolyzed and converted into polyethyleneimine.

The powder was dissolved in 5 mL of distilled water and 50 mL of 15% ammonia water was added dropwise to the solution while stirring. After the mixed solution was allowed to stand overnight, the precipitated polymer association powder was collected by filtration and the polymer association powder was washed with cold water three times. After washing, the crystal powder was dried in a desiccator at room temperature (25° C.) to obtain a linear polyethyleneimine (L-PEI). The resulting amount was 2.2 g (containing water of crystallization). In resulting polyethyleneimine obtained by hydrolysis of polyoxazoline, only a side chain changed and a main chain did not change. Therefore, the polymerization degree of L-PEI was 5000, which is the same as that before the hydrolysis.

### Examples 1 to 5

### Synthesis of Microparticles Having Needle-Like Structures on the Surface

A desired amount of the L-PEI powder was weighed and dispersed in distilled water to prepare an L-PEI dispersion having a concentration of 1%. The dispersion was heated to 90° C. in an oil bath to obtain a completely transparent aqueous solution. In the resulting L-PEI aqueous solution, a metal salt of a metal ion shown in Table 1 (Example 1: Cu (II) nitrate, Example 2: Mn (II) nitrate, Example 3: Al (III) nitrate, Example 4: Eu (III) hydrochloride, Example 5: Zr (IV) nitrate) was added in a desired amount equivalent to 1/20 of the moles of ethyleneimine units of L-PEI, and then the aqueous solution was allowed to stand in an atmospheric environment at room temperature for 24 hours and naturally cooled to room temperature to obtain a solution of the L-PEI metal complex.

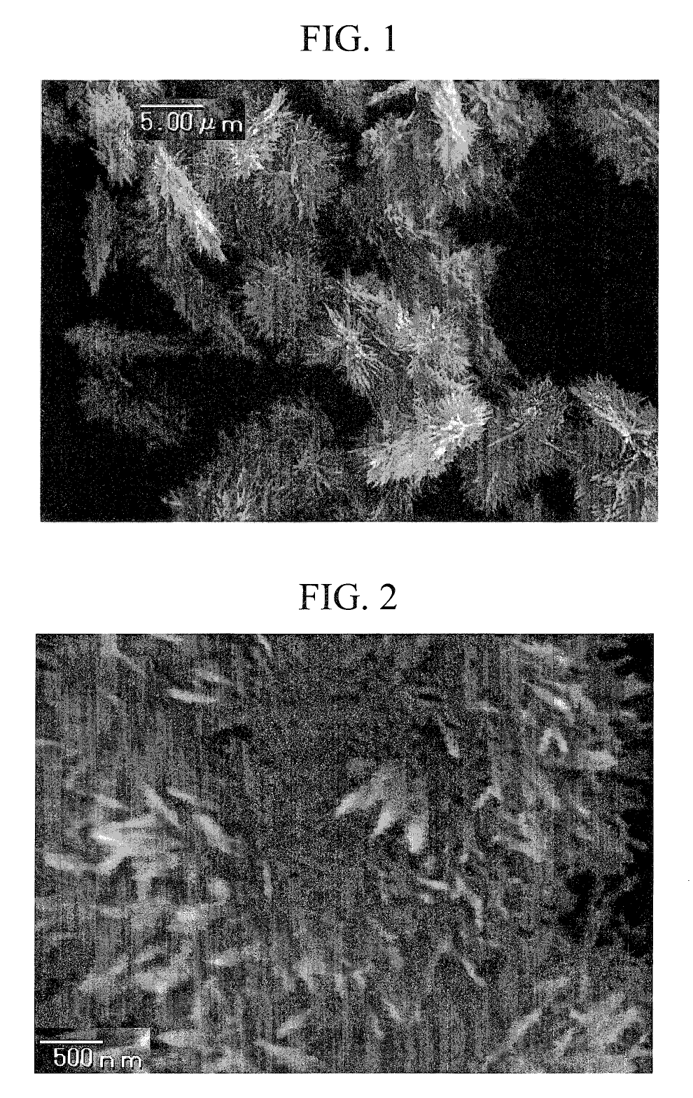

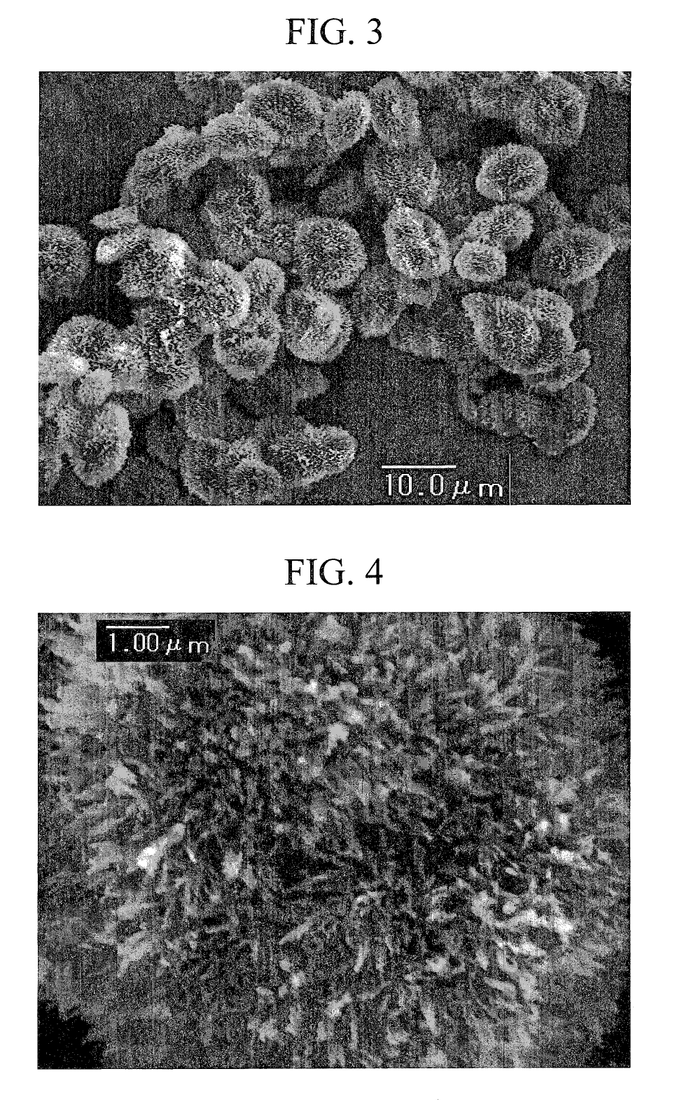

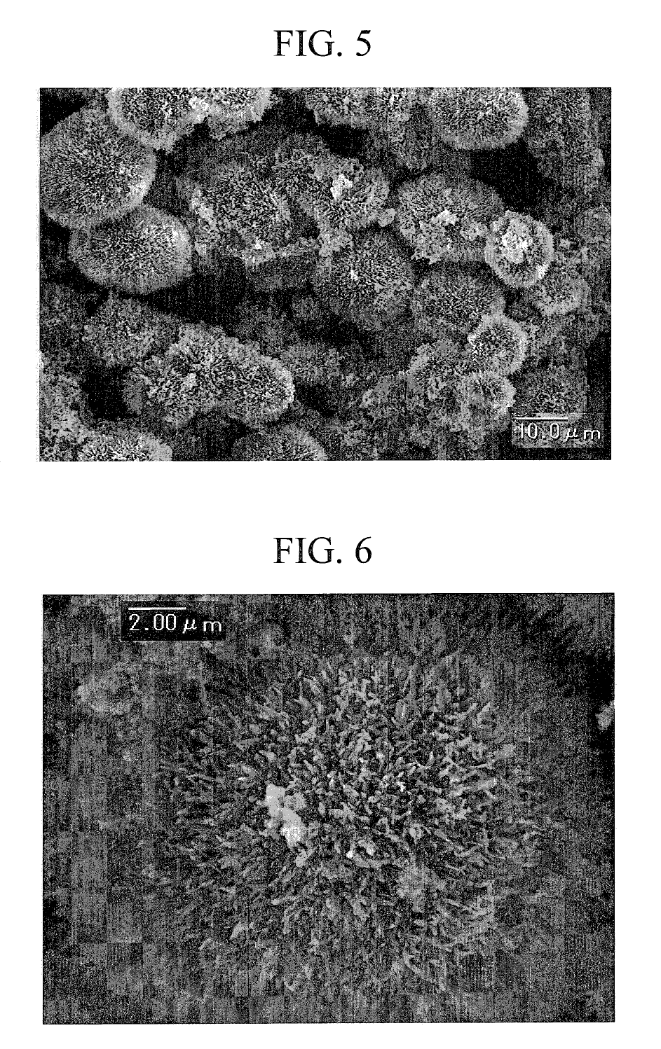

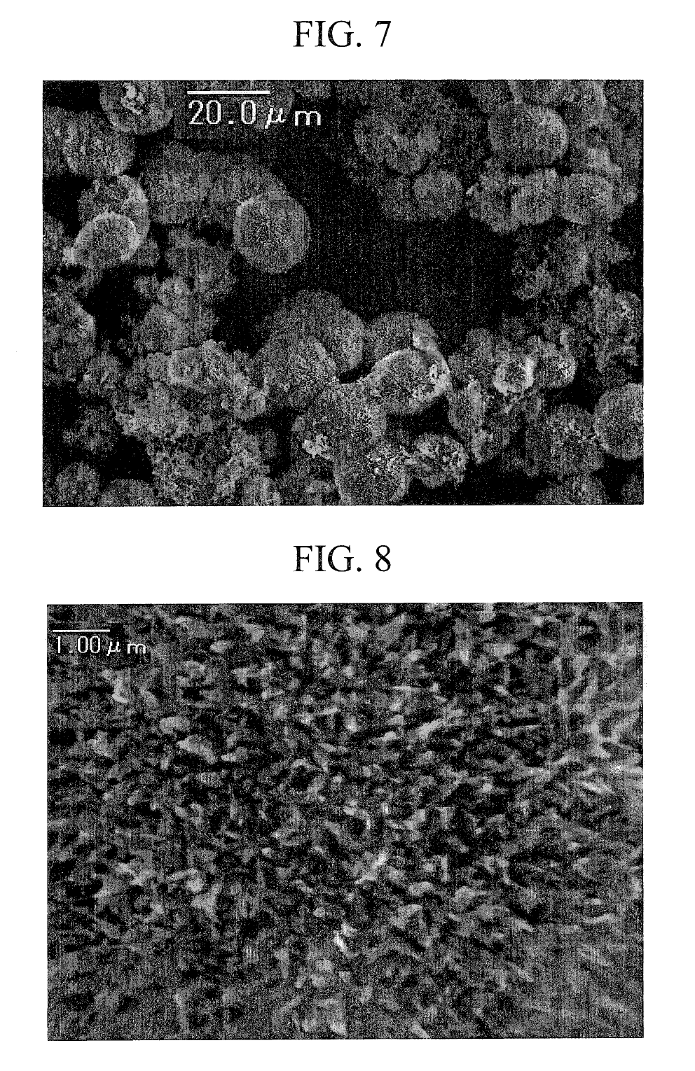

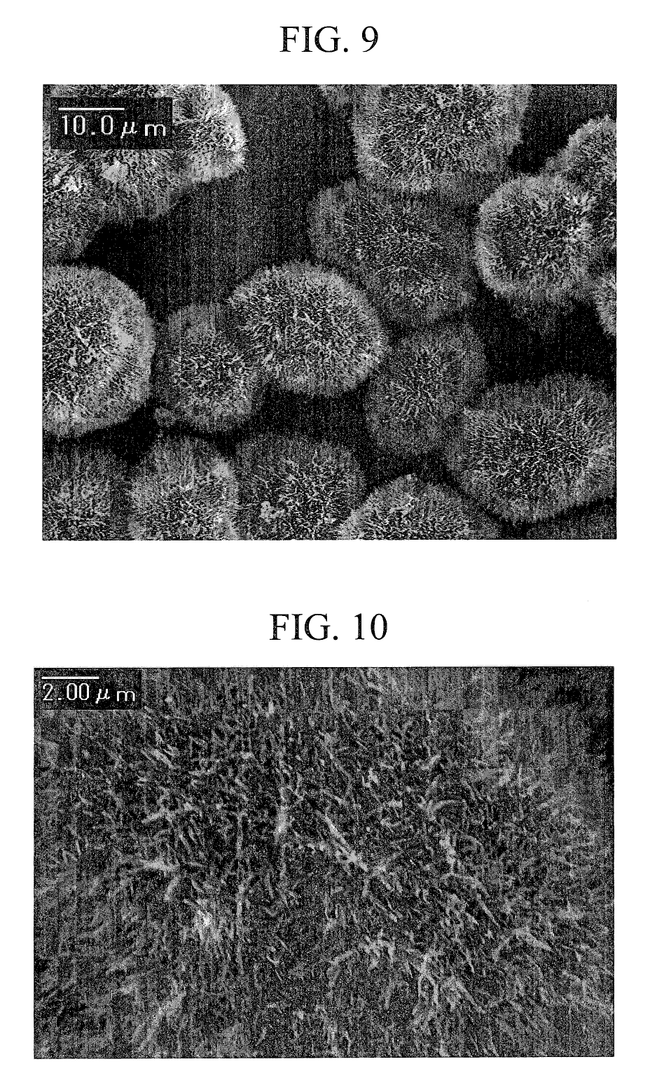

In the resulting L-PEI metal complex solution (1 mL), 1 mL of a mixed solution of tetramethoxysilane (TMSO) and ethanol in a mixing ratio of 1/1 (volume ratio) was added, and was reacted at room temperature for one hour (TMOS of 40 times equivalent to an ethyleneimine unit in a polymer was used). The resulting solid body was taken out by using a centrifuge, then washed three times using an ethanol-centrifuge process, and then a composite powder of a L-PEI metal complex and silica was obtained. The appearance of the resulting powder and the metal content/silica content are listed in Table 1. The resulting powder was observed by a scanning electron microscope. As shown in FIG. 1 to FIG. 10, the microparticles having needle-like structures on the surface which had micro-needle-like structures on the whole surface of the particle was observed.

| | Example 1 | Example 2 | Example 3 | Example 4 | Example 5 |
|---|---|---|---|---|---|
| Species of | Cu(II) | Mn(II) | Al(III) | Eu(III) | Zr(IV) |
| metal ions | | | | | |
| Metal | 0.3 | 0.5 | 0.8 | 0.5 | 0.6 |
| content (%) | | | | | |
| Silica | 82 | 79 | 80 | 78 | 80 |
| content (%) | | | | | |
| Greatest | 10 | 10 | 20 | 18 | 20 |
| dimension | | | | | |
| (μm) | | | | | |
| Appearance | Blue | Light pink | White | White | White |
| (color) | | | | | |

### Comparative Example

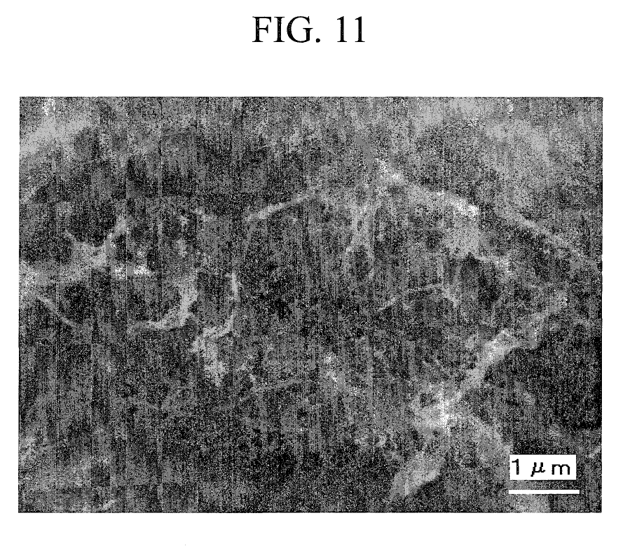

In 1 mL of the resulting L-PEI solution prepared as the same as the Example 1, 1 mL of a mixed solution of tetramethoxysilane (TMSO) and ethanol in a mixing ratio of 1/1 (volume ratio) was added, followed by slight stirring for one minute and further standing for 40 minutes. The mixture was washed with excess acetone and then washed three times using a centrifuge. The solid was recovered and dried at room temperature to obtain a composite powder containing L-PEI and silica. In the scanning electron microscope measurement of the powder as shown in FIG. 11, the composite material has a form of a fiber bundle rather than a particle. No needle-like structures was observed. It is clear, as shown in the Examples, that the metal complex made from the metal ions and the polymer was essential to obtain a composite particle having needle-like structures.

### INDUSTRIAL APPLICATION

The microparticle having needle-like structures on the surface of the present invention is a promising candidate for use in a solid electrolyte, a solid catalyst, a nanoadditive, and a nanothin-film material. In addition, the microparticle having needle-like structures on the surface which includes a metal complex of the metal ions can be changed into a metal nanoparticle by heating a treatment or a treatment of a reducing agent, so it is also a promising candidate for the use in materials containing metal nanoparticles.

The method for producing a microparticle having needle-like structures on the surface includes a step of dissolving a polymer having a linear polyethyleneimine chain and a metal ion into an aqueous medium to obtain an association of a metal complex, and a step of carrying out a sol-gel reaction using alkoxysilane at the association of the metal complex (X) as a reaction field in the presence of water. It is a simple method without the need of a special device, so it can be used as a production method in industry.

1. A microparticle having needle-like structures on a surface which comprises a polymer (a) having a linear polyethyleneimine chain, a metal ion (b) which can form a complex with the polymer (a), and silica (Y), wherein the surface of the microparticle has micro-needle-like structures.

2. The microparticle having needle-like structures on a surface according to claim 1, which further comprises a metal complex (X) made from the polymer (a) having a linear polyethyleneimine chain and the metal ion (b).

3. The microparticle having needle-like structures on a surface according to claim 1, wherein the polymer (a) having a linear polyethyleneimine chain is a block polymer, and the content of the polyethyleneimine chain in the polymer is 40 mol % or more by moles of monomers.

4. The microparticle having needle-like structures on a surface according to claim 1, wherein a greatest dimension of the microparticle is within a range from 1 to 20 μm.

5. The microparticle having needle-like structures on a surface according to claim 1, wherein the content of the silica (Y) in the microparticle is within a range from 30 to 90% by mass.

6. The microparticle having needle-like structures on a surface according to any one of claims 1 to 4, wherein the content of the metal ion (b) in the microparticle is within a range from 0.05 to 5% by mass.

7. A method for producing a microparticle having needle-like structures on a surface, comprising:
(1) a step of dissolving a polymer (a) having a linear polyethyleneimine chain and a metal ion (b) in an aqueous medium to obtain an association of a metal complex (X) made from the polymer (a) having the linear polyethyleneimine chain and the metal ion (b); and
(2) a step of carrying out a sol-gel reaction using alkoxysilane at the association of the metal complex (X) as a reaction field in the presence of water.

8. The method for producing a microparticle having needle-like structures on a surface according to claim 7, wherein the alkoxysilane is tri- or polyvalent alkoxysilane.

9. The method for producing a microparticle having needle-like structures on a surface according to claim 7, wherein in step (1), a ratio of an amount of the polymer (a) having a linear polyethyleneimine chain to those of the metal ion (b), expressed by a mole ratio of ethyleneimine units in the polymer (a) to the metal ion (b), is within a range from 5/1 to 100/1.

10. The method for producing a microparticle having needle-like structures on a surface according to claim 7, wherein the step (1) comprises:
dispersing, heating and dissolving the polymer (a) having a linear polyethyleneimine chain in an aqueous medium within a range from 0.01 to 20% by mass;
stirring the medium after adding the metal ion (b) to the medium; and
cooling the medium.

11. The method for producing a microparticle having needle-like structures on a surface according to any one of claims 7 to 10, wherein in the step (2), an amount of the alkoxysilane is 2 to 1000 times equivalent to ethyleneimine units of the polymer (a) having a linear polyethyleneimine chain.
